(19) United States
(12) Patent Application Publication
(10) Pub. No.: US 2016/0375402 A1
(43) Pub. Date: Dec. 29, 2016

(54) Method And Apparatus For Chemical Removal Of Acid Gas From Combustion Emissions And Natural Gas Streams

(71) Applicants: Philip W. Mancil, Plano, TX (US); Dennis E. Palmer, Prosper, TX (US); Heidi R. Vollmer-Snarr, Los Altos, CA (US)

(72) Inventors: Philip W. Mancil, Plano, TX (US); Dennis E. Palmer, Prosper, TX (US); Heidi R. Vollmer-Snarr, Los Altos, CA (US)

(73) Assignee: ANNI ENVIRONMENTAL, LLC, Richardson, TX (US)

(21) Appl. No.: 14/747,076

(22) Filed: Jun. 23, 2015

(51) Int. Cl. B01D 53/62; C25B 1/00

(52) U.S. Cl. CPC B01D 53/62; C25B 1/00; B01D 2251/306; B01D 2251/604

(57) ABSTRACT

A method of treating acid gas from fuel emissions or ambient air is performed by contacting the acid gas with a highly reactive reductant that has been prepared in a vessel positioned with two electrodes separated by a membrane. An electric potential is applied across the electrodes at a selected voltage and current necessary to generate a strong reductant within the cathodic cell. The reductant is pumped from the cathodic cell to a second vessel. Acid gas from fossil fuel emissions is introduced into the second vessel and upon contacting the cathodic reductant converts into its constituent salt thus sequestering the acid gas within a salt and keeping it from entering the atmosphere. Accordingly, acid gas within ambient gas can be introduced into the second chamber and sequestered in the same manner.

### FIELD OF INVENTION

This invention relates to methods and devices for treating, so that they do not become part of the atmosphere, unwanted acid gases such as, but not limited to, carbon dioxide (CO₂), nitrogen oxides (NOₓ), and sulfur dioxide (SO₂), contained within combustion gas emissions of carbon-based fuels. It also relates to methods and devices that clean acid gases, including hydrogen sulfide (H₂S) and carbon dioxide (CO₂), from natural gas and crude oil. Finally it relates to processes and methods that may reduce acid gases from confined atmospheres.

### BACKGROUND OF THE INVENTION

There is a need for a method to economically and efficiently reduce or eliminate carbon dioxide and other pollutant gases from fuel combustion emissions before they enter the atmosphere, and to reduce these same pollutant gases within the atmosphere.

With respect to carbon dioxide, current industry processes have focused on carbon sequestration, often defined as the long-term storage of carbon in subsurface reservoirs, the ocean, plants, and soils. It also includes gas and particulate capture through mechanical and chemical absorption with “wet scrubbers” to eliminate or reduce various unwanted gases before they reach the atmosphere. Wet scrubbers attached to flue stacks have had success removing sulfur acid gases and particulate matter, but have had limited success in efficiently absorbing carbon dioxide.

Chemical absorption has been successfully applied to carbon dioxide buildup from human respiration in confined atmospheres such as within a submarine, space vehicle, or space station. This technique directs confined air through finely powdered sodium or lithium hydroxide crystals where carbon dioxide is absorbed on the crystals.

Amine absorption applied to selectively remove carbon dioxide and hydrogen sulfide from natural gas streams has been used for many years in the oil and gas industry. The Benfield Process is another method used in the oil and gas industry to strip carbon dioxide and hydrogen sulfide from gas streams. It uses a potassium carbonate solution to chemically absorb these two acid gases.

In addition to absorption, pressure swing adsorption using activated carbon and zeolite as solid sorbents has also been used to separate carbon dioxide and other acid gases from natural gas streams.

### SUMMARY OF THE INVENTION

Described devices and methods electrochemically create a continuous supply of highly reactive reducing agent(s) within an aqueous solution and concurrently, or separately contact the reducing solution with targeted acid gases in such a way that acid gases are chemically absorbed into solution. Accordingly, the devices and methods of the invention are much more efficient and thus more economical than similar devices and methods used to contact and chemically absorb acid gas.

### BRIEF DESCRIPTION OF DRAWINGS

The following drawings are used to provide a detailed description of the devices and processes of the invention and the advantages thereof:

FIG. 1 is a schematic drawing of the gas processing chamber 10 and electrolysis chamber 12 as they fit together to process acidic oxide gas.

FIG. 2 schematic drawing of the gas-processing chamber 10 showing in dashed lines the position of Sections 40 and 42.

FIG. 3 is a schematic section drawing of the gas-processing chamber 10 of Section 40 in FIG. 2.

FIG. 4 is a schematic section drawing of the gas-processing chamber 10 of Section 42 in FIG. 2

FIG. 5 is a schematic section drawing of the gas-processing chamber 10 of Section 40 in FIG. 2 showing the direction of and path of gas flow as it moves through the gas-processing chamber 10.

FIG. 6 is a schematic drawing of the electrolysis chamber.

FIG. 7 is a schematic section drawing of Section 42 in FIG. 6.

### DETAILED DESCRIPTION OF THE INVENTION

It is commonly known that when acid gases are contacted with certain reducing agents in aqueous solutions they will chemically react with the reducing agent within solution and convert from a gas state to into their constituent salt. For example, carbon dioxide (CO₂) when contacted with an aqueous solution of potassium hydroxide (KOH) yields potassium carbonate (K2CO3) and upon further contact with CO₂ yields potassium bicarbonate (KHCO₃). The same salt conversion process occurs within an aqueous solution of sodium hydroxide (NaOH) that has been contacted with CO₂. The end salt in this case is sodium bicarbonate (NaHCO₃). This gas to salt conversion is called chemical absorption. Devices and methods described electrochemically generate an extraordinarily reactive reducing species within aqueous solution and contact it with targeted acid gases through technology similar to wet scrubbers. Accordingly, research (paragraph 0048) indicates that the method of the invention is 7.5 times more efficient and thus much more economical than wet scrubbers using various other reducing agents (generally caustics) to contact and convert acid gas to its respective salt. The invention is particularly efficient in processing carbon dioxide gas.

In certain embodiments, the invention is constructed of two components that work together to chemically absorb acid gas. An embodiment of the invention may consist of an electrolytic cell, herein referred to as an electrolytic chamber, and a separate vessel herein referred to as a gas-processing chamber. Other embodiments may consist of just the electrolytic cell that serves as both a gas processor and an electrolytic cell.

In reference to the two-chambered embodiment, the chambers are connected via conduit and are engineered to work together to chemically absorb externally introduced acid gas. Operational design of the electrolytic chamber should be engineered to maximize generation of reductant at the cathode, and efficiently deliver it in aqueous solution to the gas-processing chamber. It functions as follows: Reducing solution at exit from the cathodic cell is slowly pumped through a conduit to enter the gas-processing chamber. Upon entering the gas-processing chamber, the solution moves through the chamber, treats introduced gas on its way through, and exits the chamber. At exit it moves through another conduit back to the electrolytic chamber whereupon it reenters the cathodic cell, and circulates slowly past and around the cathode to exit again on its way to the gas-processing chamber. Upon moving past the cathode, the solution is electrochemically supplied with newly generated reducing agents and upon exit from the cathodic chamber it returns to process gas within the gas-processing chamber.

A certain embodiment of the electrolytic chamber is designed to separate the cathodic cell from the anodic cell with a membrane that can be a cation-selective membrane or some other membrane designed to concentrate negative ions within the cathodic cell and reduce their migration to the positive electrode within the anodic cell. However, other embodiments may use methods that do not include a membrane to concentrate cathodic generated reducing solution.

Electrodes used within the electrolytic chamber can be high quality Mixed Metal Oxide (MMO) electrodes, but other electrodes may be used such as graphite, graphene, or any other electrode that is suitable for commercial use in an electrolytic cell.

A variable voltage DC power supply powers the electrolytic chamber and can be adjusted to accommodate the supply need of reducing ions required to react with the volume of acid gas introduced at any given time to the gas processing chamber. Multiple electrolytic chambers can be employed to supply greater need. Certain embodiments of the invention can employ multiple electrolytic chambers and multiple gas-processing chambers working simultaneously to meet the absorption need of inlet acid gas.

The internal surface of the electrolytic chamber, gas-processing chamber, and associated circulation conduit is constructed of electrically non-conductive material. However, the gas-processing chamber may be constructed of conductive materials in certain embodiments.

The electrolytic chamber decomposes water at the cathode to negative hydroxyl (OH⁻) ions and positive hydronium ions (H₃O′). Hydronium is immediately attracted to the cathode and converted to hydrogen gas where it moves to the surface and is expelled from the system. It is apparent from research results that the cathodic cell generates one or more reducing agents in addition to the hydroxyl ion. These reducing agents have not been analytically identified, but they are singularly responsible for the highly negative oxidation-reduction potential (ORP) measured within treated water in the cathodic cell. This ORP value of the treated electrolyte normally exceeds −800 mV in comparison to the untreated electrolyte which, depending upon concentration, generally has a positive ORP. Research also indicates that the presence of these unidentified reductants is the reason that a cathode treated concentration of hydroxide solution is much more efficient and economical in chemical absorption of acid gas than the same concentration of an untreated hydroxide solution.

In support of this research, a treated sample of KOH (paragraph 0048) with a concentration of just 11,990 ppm KOH, recorded an −850 ORP with a pH of 13.3. The same untreated 11,990 ppm sample had an ORP of just +35 mV with the same accompanying pH of 13.3. The experiment in paragraph 0048 demonstrated that the treated solution is at least 7.5 times more efficient in the chemical absorption of CO₂ than the untreated solution. Incidentally, since the ORP decrease of the treated solution did not increase the pH of the solution, this indicates that the reductant generated from electrolysis may not be basic and may be acid neutral.

Research indicates that at least one of the reductant species of the treated solution is metastable when stored in an open atmospheric environment outside the electrical influence of the cathodic cell. It has been observed the low negative ORP slowly changes back to the original ORP of the untreated caustic solution within a few days to a few weeks. Based on our observations, it is likely that the stored treated solution is chemically absorbing atmospheric CO₂. Conversely, normally prepared hydroxide solutions are very stable when stored in the same environment and during the same period of time. Accordingly, test results support these observations and clearly demonstrate that untreated solutions are not as efficient as cathodic-treated solutions in chemically absorbing carbon dioxide and other acid gas. At this point, it is not clear how the unidentified reductants react with hydroxyl ions to change the efficiency of chemical absorption, but it is clear that they work alongside the hydroxyl ion to significantly accelerate chemical absorption of acid gas.

Electrolyte used in the electrolytic cell may be, but is not limited to, alkali metal hydroxides, alkali metal halides, and potassium and sodium carbonate. In each case, when these electrolytes are electrochemically treated at the cathode, the unidentified reductants are generated within the cathodic solution. They are then available with their hydroxyl companions to chemically absorb acid gas. Selection of the electrolyte determines the type of salt and its solubility, and accordingly, the method and ease of harvest from the electrolyte. Salt harvest processes may be designed to occur simultaneously with the absorption process which may be the case when using calcium hydroxide (Ca(OH)₂) as an electrolyte.

At a minimum, electrolyte concentration should be sufficient to provide current between the electrodes that adequately supplies the reductants necessary to absorb the volume of acid gas to be contacted and absorbed. Since salt is a product of both acid gas and electrolyte there needs to be a method to continuously replace the electrolyte as salt is harvested from solution so as to maintain the desired electrolyte concentration.

Operational design of the Gas Processing Chamber is engineered to:

deliver the reducing solution generated from the cathodic cell so that it efficiently contacts maximum surface area of supplied volume of inlet acid gas;

provide ample exposure time for the acid gas to be completely absorbed by reducing solution;

provide means to simultaneously harvest acid gas salts during operation of the absorbing process; and

provide means to renew the electrolyte as salts are harvested.

In more detail, the reducing solution within the cathodic cell is outlet from the base of the cathodic cell and pumped through a conduit to inlet at the top of the gas-processing chamber where it circulates down through the gas-processing chamber to outlet at its base. Its flow direction from top to bottom is opposite the flow of direction of inlet gas, which is from bottom to top. Industry calls this countercurrent flow, and it has been shown to be highly efficient in this embodiment, but other flow patterns seem to work well. From outlet the aqueous solution travels through another conduit to inlet at the top of the cathodic cell. Circulation of the reducing solution from one chamber to the next is slow and continuous.

The delivery of cathodic solution to the gas processing chamber may be engineered to be harvested directly off the cathode to optimize reductant concentration delivered to the gas processing chamber. One way this can be done is by shrouding the lower portion of the cathode (electrode) and providing an outlet at the base of the shroud via conduit to the outlet to the base of the cathodic cell and then to the pump. However, other designs may be equally as efficient.

Combustion gas, which includes targeted acid gases, is inlet at the base of the gas-processing chamber through a check valve and then travels vertically up through the gas processing chamber to outlet at the top. Gas travels in opposing or countercurrent direction to down circulating reducing solution.

Acid gasses including carbon dioxide (CO₂), nitrogen oxides (NOₓ), and sulfur dioxide (SO₂) react with the reducing agents in solution and are chemically absorbed as salts. The alkali metal in the converted salt is the same metal in the electrolyte of choice.

The purpose of the circulation is to provide the gas-processing chamber with a continuous supply of reductant needed to react with newly entering acid gas and continue chemical gas absorption in a regenerative mode.

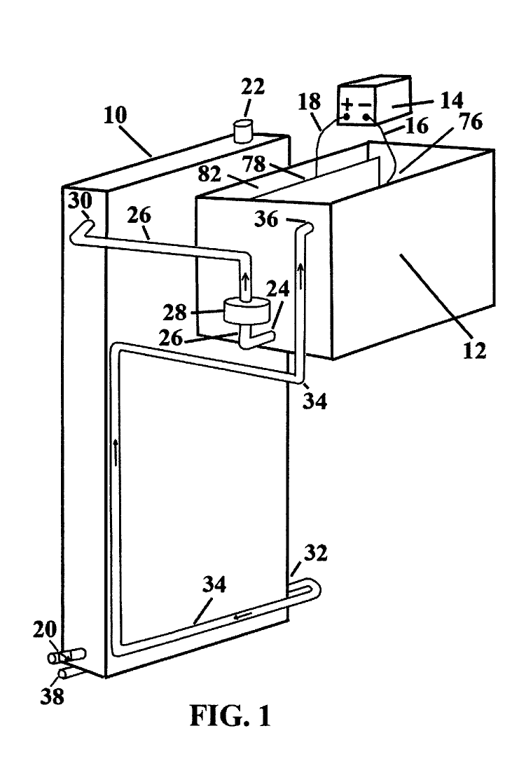

Referring to the invention in more detail, FIG. 1 is a schematic of a simplistic embodiment of one form of the invention. The embodiment in FIG. 1 places the top of the electrolytic solution in the side-by-side vessels at the same level, but other embodiments may have fluid levels at different elevations. It shows two side-by-side vessels referred to as the electrolytic chamber 12 and gas-processing chamber 10. The two chambers are connected via conduits 26, 34. The purpose of the conduit is to circulate reducing solution from the electrolytic chamber 12 to the gas-processing chamber 10 and return it back to the electrolytic chamber 12.

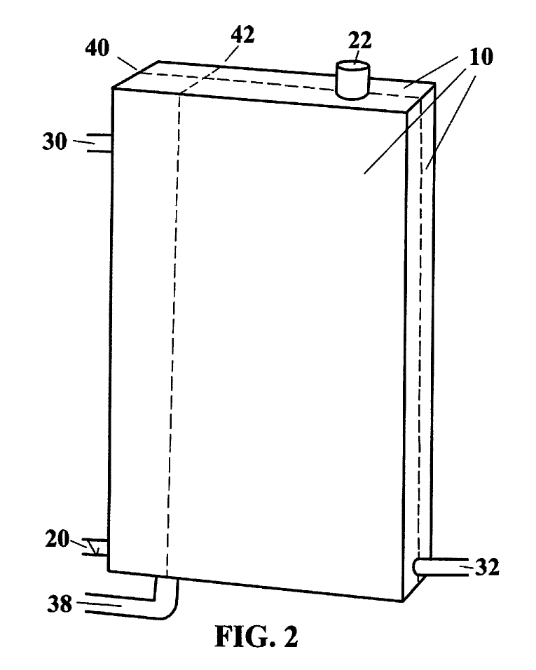

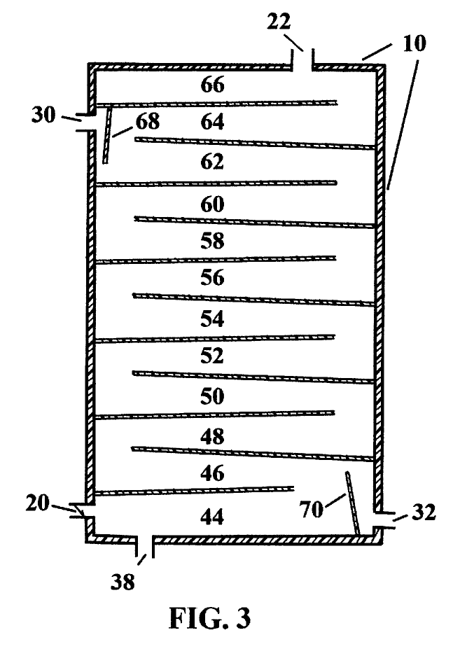

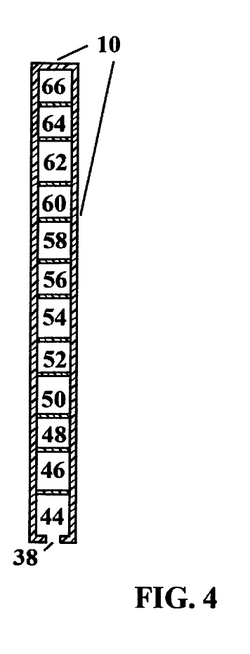

FIG. 2 is a schematic drawing of the gas-processing chamber 10. It illustrates in dashed line the planes of Sections 40 and 42. FIG. 3 is a schematic drawing of the plane of Section 40 of gas-processing chamber 10 depicted in FIG. 2. It shows the internal structure of the wide dimension of gas processing chamber 10 and twelve internal cells 44 through 66. FIG. 4 is a schematic drawing of the plane of Section 42 depicted in FIG. 2 that shows the internal structure of the narrow dimension of the gas processing chamber 10 and cells 44 through 66.

Water within the cathodic cell 76 (FIGS. 1 and 7) is decomposed by a variable voltage DC power supply 14 at the cathode 74. This decomposition generates the reducing solution that exits 24 the cathodic cell 76, travels through a conduit 26 to a pump 28, then is pumped slowly through the conduit 26 to inlet 30 the gas-processing chamber 10. From inlet 30 it travels down in succession from cells 62 to 44 (FIGS. 3 and 4) to an outlet 32 near the chamber's 10 base. From outlet 32 the solution travels through a conduit 34 to inlet 36 back into the cathodic cell 76 of the electrolytic chamber 12.

Referring to FIG. 3, gas, including acid gas to be treated, is inlet into the gas-processing chamber 10 into cell 44 near the base of the gas processing chamber 10 through a check valve 20. From entry into cell 44 the gas travels in upward succession through cells 46 to 66 and exits cell 66 at an outlet 22 at the top of the gas-processing chamber 10. Upward gas flow is countercurrent to downward circulating reducing solution.

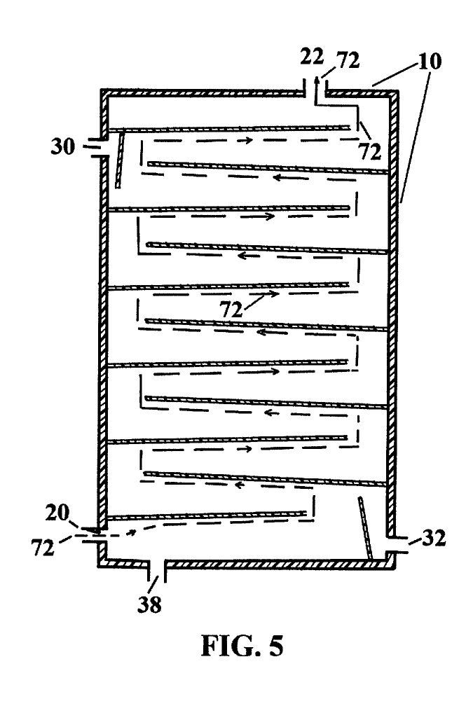

The twelve internal cells 44 through 66 of FIGS. 3 and 4 control the travel path for downward moving reducing solution and the upward path of inlet gas. FIG. 5 shows the direction by arrow and the path 72 of gas travel. In reference to FIG. 3, gas is inlet into cell 44 through a check valve 20 and immediately goes vertically to the top or ceiling of cell 44. Gas travels up a slight angle on the ceiling of cell 44 to an opening allowing the gas to rise to cell 46. From there it travels vertically to the ceiling of cell 46 and travels up angle on the ceiling of cell 46 to an opening to cell 48. It travels upward through succeeding cells 48 through 66 in the same manner as described from cells 44 and 46, and as illustrated by dashed lines and arrows 72 in FIG. 5.

Reference to FIG. 3, baffle 68 is placed to stop turbulence of inlet reducing solution and baffle 70 is placed to stop incoming gas from exiting into the reducing solution return outlet 32.

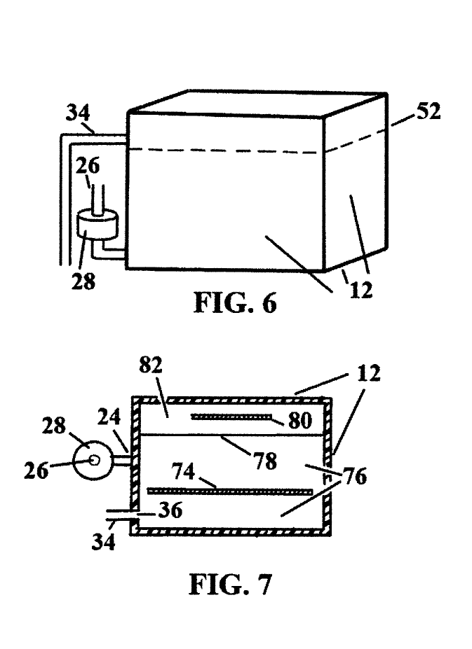

The electrolytic chamber 12 is displayed in FIGS. 1, 6, and 7. A variable voltage DC power supply 14 (FIG. 1) provides the electricity needed to decompose water at the cathode 74 and anode 80 (FIG. 7). Negative 16 and positive 18 leads connect DC current from power supply 14 to the cathode 74 and anode 80 respectively (FIGS. 1 and 7). The membrane 78 (may be a cation selective membrane) separates the cathodic cell 76 from the anodic cell 82. The purpose of the membrane 78 is to keep reductants generated at the cathode 74 within the cathodic cell 76 so that they concentrate to make a rich reducing solution that can be circulated through the gas-processing chamber 10. In addition to cation selective membranes other membrane materials may also be used to accomplish maximum concentration of nucleophiles in the cathodic cell 76.

### EXAMPLE

### Experimental

Experiments were conducted within gas-processing chamber 10 (FIGS. 1, 2, 3 and 5) to examine chemical absorption efficiency of carbon dioxide (CO₂) contacted with an equal volume and concentration of cathodic-treated solution and an untreated solution of potassium hydroxide (KOH). Six tests were conducted using untreated and treated 15,000 ppm (1.5%), 30,000 ppm (3%) and 45,000 ppm (4.5%) KOH solution and are labeled Tests 1 through 6 respectively. The volume of the solution conducted in each test within gas-processing chamber 10 was 37.85 liters (10 gallons). Metered CO₂ was introduced into gas inlet 20 (FIGS. 1, 2, 3 and 5) to the 37.85 liters of solution of all six tests in order to supply the exact volume of CO₂ gas per minute for each test. The purpose of the testing procedure was to determine if a treated KOH solution absorbed more CO₂ than an untreated KOH solution of the same volume and KOH concentration.

An oxygen meter was placed in the gas outlet 22 (see FIG. 5) within the top of the gas-processing chamber, just above the fluid level, to measure oxygen volume change, with the idea that when oxygen levels dropped below normal atmospheric levels, that event in time marked the initial arrival of CO₂. Since the gas-processing chamber 10 is constructed of transparent polycarbonate plastic, the absorption of the CO₂ gas stream is also easily visible, providing a check on the oxygen meter located above the fluid level. Vertical gas travel (FIG. 5, 72) distance in the gas processing chamber 10 is approximately 4.88 meters (16 linear feet) from entry to the top of the fluid level.

Test 1: Metered CO₂ gas was introduced into gas processing chamber 10 containing 37.85 liters of untreated 15,000 ppm KOH solution. Initial oxidation potential of the solution was −52 mV. CO₂ gas was observed at the surface of the solution 57 minutes into the test.

Test 2: Metered CO₂ gas was introduced into gas processing chamber 10 containing 37.85 liters of treated 15,000 ppm KOH solution. Initial oxidation potential of the solution was −968 mV. CO₂ gas was observed at the surface of the solution at 80 minutes into the test.

Test 3: Metered CO₂ gas was introduced into gas processing chamber 10 containing 37.85 liters of untreated 30,000 ppm KOH solution. Initial oxidation potential of the solution was −76 mV. CO₂ gas was observed at the surface of the solution at 151 minutes into the test.

Test 4: Metered CO₂ gas was introduced into gas processing chamber 10 containing 37.85 liters of treated 30,000 ppm KOH solution. Initial oxidation potential of the solution was −960 mV. CO₂ gas was observed at the surface of the solution at 217 minutes into the test.

Test 5: Metered CO₂ gas was introduced into gas processing chamber 10 containing 37.85 liters of untreated 45,000 ppm KOH solution. Initial oxidation potential of the solution was −78 mV. CO₂ gas was observed at the surface of the solution at 295 minutes into the test.

Test 6: Metered CO₂ gas was introduced into gas processing chamber 10 containing 37.85 liters of untreated 45,000 ppm KOH solution. Initial oxidation potential of the solution was −960 mV. CO₂ gas was observed at the surface of the solution at 360 minutes into the test.

Test Conclusions: These tests clearly show that electrochemically treated KOH solution from the cathodic cell chemically absorbs greater volumes of contacted carbon dioxide over a given period of time than an untreated solution of KOH of the same concentration. Therefore, electrochemically treated KOH solution is more efficient than untreated KOH solution in absorbing CO₂ gas. Significantly, the treated 15,000 ppm KOH solution is 40% more efficient than untreated 15,000 ppm solution (tests 1 and 2), the treated 30,000 ppm KOH solution is 44% more efficient than untreated 30,000 ppm solution (tests 3 and 4), and the treated 45,000 ppm KOH solution is 22% more efficient than untreated 45,000 ppm solution (tests 5 and 6). These efficiency numbers are likely minimums due to the short vertical travel distance (4.88 meters) of CO₂ gas in gas processing chamber 10. This may explain lower efficiency percentage (22%) between tests 5 and 6. Of interest, the difference in processing time between test 4 and 5 and test 5 and 6 was 66 minutes (217−151) and 65 minutes (360−295) respectively.

Absorption of CO₂ in a KOH solution yields potassium bicarbonate (KHCO₃). All of the tests were conducted in water at approximately 20° C. (68° F.) and, since KHCO₃ does not become saturated until it reaches approximately 337,000 ppm, the conclusion is that none of the tests reached the saturation limit of KHCO₃. Accordingly, it can be concluded that the KOH solutions in all six tests were actively absorbing CO₂ at the point of first occurrence of CO₂ at the surface in the gas processing chamber 10; prior to that the solution in each test was removing 100% of the introduced CO2 gas.

The data from the six tests indicate that treated KOH solution is more reactive to CO₂ gas than an untreated KOH solution and may be catalyzed by an unknown catalyst derived from being electrochemically treated in the cathodic cell. The treated KOH solution had a much lower ORP (−960 to −968) than the untreated KOH (−52 to −78) solution. Since the negative ORP of the treated KOH solution dropped significantly during the test, it is thought that reductive nature of the treated KOH solution may be catalyzing the absorption of CO₂ gas. Nonetheless, further testing is necessary to determine exactly why the treated KOH solution accelerates chemical absorption of CO₂ gas.

Experiments were conducted using various electrolytes such as sodium and potassium hydroxide, sodium chloride, calcium hydroxide, sodium carbonate and potassium carbonate. The cathodic solutions from all of the tested electrolytes were all efficient acid gas absorbers. However, it should be pointed out that the use of calcium hydroxide upon contact with carbon dioxide caused immediate precipitation of calcium carbonate and, of course, the use of chlorides has the complication of corrosive chlorine gas evolution at the anode. For these reasons the preferred electrolytes used in the prototype studies were sodium or potassium hydroxide. However, because sodium and potassium chloride are very inexpensive, they may eventually be the electrolyte of choice in the commercial removal of acid gases.

While the invention has been shown in some of its forms, it should be apparent to those skilled in the art that it is not so limited, but is susceptible to various changes and modifications without departing from the scope of the invention.

I claim:

1. A method of treating acid gas comprising:
contacting the acid gas with an aqueous reductive treatment fluid prepared in a treatment system comprising a vessel containing an aqueous fluid and a pair of electrodes separated by an ion selective membrane positioned within the aqueous fluid when an electric potential is applied across the pair of electrodes at a selected voltage and current so that the aqueous reductive treatment fluid within the cathodic cell is suitable for converting acid gas into its constituent salt.

2. The method of claim 1, wherein:
acid gas is contacted with the treatment fluid after the treatment fluid is removed from the treatment system.

3. The method of claim 1, wherein:
acid gas is contacted with the treatment fluid within the cathodic cell of the treatment system.

4. The method of claim 1, wherein:
contacting the acid gas with the treatment fluid converts all or substantially all of the acid to its constituent salt.

5. The method of claim 1, wherein:
the acid gas contacted and converted to its natural salt by the aqueous treatment fluid may be a constituent of fossil fuel emission, natural gas streams, various polluted gases, and ambient atmospheric air; and may be various concentrations of carbon dioxide, sulfur dioxides, nitrogen oxides, and hydrogen sulfide gas.

6. A method of treating acid gas comprising:
contacting the acid gas with an aqueous reductive treatment fluid prepared in a treatment system comprising a vessel containing an aqueous fluid and a pair of electrodes engineered in a manner that will produce a predominant volume of reductants within the aqueous fluid when an electric potential is applied across the pair of electrodes at a selected voltage and current so that the aqueous reductive treatment fluid within the aqueous fluid is suitable for converting acid gas into its constituent salt.

7. The method of claim 6, wherein:
acid gas is contacted with the treatment fluid after the treatment fluid is removed from the treatment system.

8. The method of claim 6, wherein:
acid gas is contacted with the treatment fluid within the treatment system.

9. The method of claim 6, wherein:
the acid gas contacted and converted to its salt by the aqueous treatment fluid may be a constituent of fossil fuel emission, natural gas streams, various polluted gases, and ambient atmospheric air; and may be various concentrations of carbon dioxide, sulfur dioxides, nitrogen oxides, and hydrogen sulfide gas.
